(19) United States
(12) Patent Application Publication
(10) Pub. No.: US 2020/0142972 A1
(43) Pub. Date: May 7, 2020

(54) SYSTEM AND METHOD FOR IDENTIFYING OPEN SOURCE REPOSITORY USED IN CODE

(71) Applicant: WHITESOURCE LTD., Bnei Brak (IL)

(72) Inventors: Aharon ABADI, Bnei Brak (IL); Doron COHEN, Bnei Brak (IL); Ofir BECKER, Bnei Brak (IL)

(21) Appl. No.: 16/180,142

(22) Filed: Nov. 5, 2018

(51) Int. Cl. G06F 17/30

(52) U.S. Cl. CPC G06F 17/30109; G06F 17/3023; G06F 17/30097

(57) ABSTRACT

A computer-implemented method, system and computer program product, the method comprising: obtaining a multiplicity of files; dividing the multiplicity of files into disjoint file subsets, such that all files in each file subset from the disjoint file sets are contained in a different combination of repository and repository tag, comprising: searching for repository tag and repository combinations in which each file is contained; and selecting a subset of the repository tag and repository combinations which contain all files, such that one or more repository and repository tag combinations containing a collection of files is selected over one or more other repository and repository tag combinations containing the collection of files, in accordance with one or more value indications associated with each repository and repository tag combination; and outputting the repository and repository tag combination for each of the file subsets.

### TECHNICAL FIELD

The present disclosure relates to open source in general, and to a system and apparatus for checking whether given files belong to an open source repository, and which one, in particular.

### BACKGROUND

Open source relates to computer code that is publicly available and may be freely accessed and used by programmers in developing code. Open source may be provided as executables, binary files or libraries to be linked with a user's′ project, as code files to be compiled with a user's project, as code snippets to be added and optionally edited by a user as part of a file, as any other format, or in any combination thereof.

Open source may be used for a multiplicity of reasons, such as but not limited to: saving programming and debugging time and effort by obtaining a functional verified unit; porting or programming code to an environment in which the user has insufficient experience or knowledge; adding generic options such as graphic support, printing, or the like, or other purposes. The ease of obtaining such code on the Internet has greatly increased the popularity of its usage.

Despite the many advantages, open source may also carry hazards. One such danger may relate to the need to trust code received from an external source. Such code may contain bugs, security hazards or vulnerabilities, time or space inefficiencies, or even viruses, Trojan horses, or the like.

Another problem in using open source relates to the licenses which may be associated with any open source unit. Any such license may incur specific limitations or requirements on a user or a user's project developed using the open source.

Some licenses may require copyright and notification of the license. Others may require that if a user modified the used open source, for example fixed a bug, the user shares the modified version with other users in the same manner as the original open source was shared. Further licenses may require sharing the users' code developed with the open source with other users. The extent for which sharing is required may vary between files containing open source, and the whole user project. Further requirements may even have implications on the user's clients which may use the project developed with open source.

Open source may also pose legal limitations, such as limitations on filing patent applications associated with material from the open source, the inability to sue the open source developer or distributor if it does not meet expectations, or the like.

Once the requirements associated with using an open source are known, a user may decide whether it is acceptable for him or her to comply with the requirements, take the risks, and use the open source.

However, situations exist in which it is unknown whether a program was developed using open source or not, and which open source was used. In such situations, a user does not know the risks and obligations implied by the code. Such situations may occur, for example, when a programming project is outsourced to an external entity, when a programmer left the company and did not update his colleagues, in large companies possibly employing program development teams at multiple sites, or the like.

### BRIEF SUMMARY

One exemplary embodiment of the disclosed subject matter is a computer-implemented method comprising: obtaining a multiplicity of files; dividing the multiplicity of files into disjoint file subsets, such that all files in each file subset from the disjoint file sets are contained in a different combination of repository and repository tag, comprising: searching for repository tag and repository combinations in which each file is contained; and selecting a subset of the repository tag and repository combinations which contain all files, such that one or more repository and repository tag combinations containing a collection of files are selected over one or more other repository and repository tag combinations containing the collection of files, in accordance with one or more value indications associated with each repository and repository tag combination; and outputting the repository and repository tag combination for each of the file subsets. Within the method, the value indication optionally relates to meta data associated with the repository or repository tag. Within the method, the value indications optionally comprise a popularity index of the repository or repository tag. Within the method, the value indications optionally comprise a number or quality of external links pointing at the repository. Within the method, the value indications optionally comprise a number of files in the files subset contained in a repository. Within the method, the value indications optionally comprise a ratio between a number of files in the files subset and a number of files in a repository that contains the files, such that a higher ratio indicates a higher value for the indication. Within the method, a repository and repository tag combination is optionally selected over a second repository and second repository tag combination, wherein the second repository contains the repository. Within the method, searching for the repository tag and repository combinations optionally comprises using a vector representation of repository tags associated with each repository and files associated with each repository tags. Within the method, the vector representation is optionally a compact vector representation. Within the method, the vector representation optionally comprises a sequence of byte pairs, wherein a first byte in each byte pair comprises a code and wherein the second byte in each byte pair represents a number to be read in accordance with the code. Within the method, the code is optionally selected from the group consisting of: a value of the second byte represents a number of consecutive zeros; the value of the second byte represents a number of consecutive ones; the value of the second byte multiplied by two represents a number of consecutive zeros; the value of the second byte multiplied by two represents a number of consecutive ones; the value of the second byte multiplied by three represents a number of consecutive zeros; the value of the second byte multiplied by three represents a number of consecutive ones; two in a power of the value of the second byte represents a number of consecutive zeros; and two in the power of the value of the second byte represents a number of consecutive ones. Within the method, selecting the subset of the repository tag and repository combinations optionally comprises: determining two or more repositories containing a first set of files; and selecting from the repositories, a repository whose value is higher than a value of another of the at least two repositories. The method can further comprise repeating said determining and said selecting from the two or more repositories, for the files excluding the first set of files.

Another exemplary embodiment of the disclosed subject matter is a computerized apparatus having a processor, the processor being adapted to perform the steps of: obtaining a multiplicity of files; dividing the multiplicity of files into disjoint file subsets, such that all files in each file subset from the disjoint file sets are contained in a different combination of repository and repository tag, comprising: searching for repository tag and repository combinations in which each file is contained; and selecting a subset of the repository tag and repository combinations which contain all files, such that one or more repository and repository tag combinations containing a collection of files are selected over one or more other repository and repository tag combinations containing the collection of files, in accordance with one or more value indications associated with each repository and repository tag combination; and outputting the repository and repository tag combination for each of the file subsets.

Yet another exemplary embodiment of the disclosed subject matter is a computer program product comprising a computer readable storage medium retaining program instructions, which program instructions when read by a processor, cause the processor to perform a method comprising: obtaining a multiplicity of files; dividing the multiplicity of files into disjoint file subsets, such that all files in each file subset from the disjoint file sets are contained in a different combination of repository and repository tag, comprising: searching for repository tag and repository combinations in which each file is contained; and selecting a subset of the repository tag and repository combinations which contain all files, such that one or more repository and repository tag combinations containing a collection of files are selected over one or more other repository and repository tag combinations containing the collection of files, in accordance with one or more value indications associated with each repository and repository tag combination; and outputting the repository and repository tag combination for each of the file subsets.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a system for determining whether and which open source repository is used in given files, in accordance with some exemplary embodiments of the subject matter; and

FIGS. 2A and 2B show a flowchart of steps in a preparatory method and a runtime method, respectively, for determining whether and which open source repository is used in given files, in accordance with some exemplary embodiments of the subject matter.

### DETAILED DESCRIPTION

The term repository relates to an open source project provided to the public, which is accessible to and can be used by developers. The repository can comprise a multiplicity of files, each may be a binary, comprise source code, or be in any other format. The repository may be received and stored in a database or another collection, which provides access to open source repositories, and processed in accordance with the disclosure.

An open source repository may be associated with various tags, wherein a tag relates to a version of the open source repository. A tag may also be referred to as “repository tag”. For example, if a user used an open source repository and introduced changes, the user may return the changed repository to the open source collection, to be available to future users. The returned content is associated with the same repository, but is referred to as having a different repository tag. Each open source project is thus associated with a repository and tag, and comprises one or more files.

Thus, an open source database may comprise millions of repositories, hundreds of millions of tags, and billions of files.

One technical problem dealt with by the disclosed subject matter is the need to detect whether one or more files are taken from one or more repositories. If some or all of the files are taken from an open source repository, it is required to identify from which repository and which tag thereof the files are taken.

Another technical problem relates to making said determination in an efficient manner, such that it can be done in reasonable time. Due to the huge amount of files stored in an open source database, and the amount of repositories and tags, such check can take a long time, and moreover be non-scalable, such that an increase in the number of available open source repositories results in a larger increase in the time or computing resources required for determining the repositories and tags.

One technical solution comprises a method and apparatus for discovering whether and which open source repositories and tags comprise files that are contained within a multiplicity of files. The method includes a preparatory stage in which each file is associated with an identifier, computed for example as a hash value or another unique identifier. Each tag is also associated with a unique identifier, for example an integer between 0 and the number of tags minus one. Each file is then associated with a data structure containing indications in which tags the file is contained. In some embodiments, the indication may be implemented as a vector having a length of at least the number of available tags. In such embodiment, each entry in the vector indicates whether the file is contained in the tag having an identifier equal to or related to the index of the entry.

In run time, subject to receiving a collection of files, referred to as the original collection, for each file the following items are determined using the data structure described above: the tags in which the file is contained, and the repository associated with the tag. Thus, for each repository the files from the original collection contained in tags associated with the repository are determined.

A maximal group of files contained in the same one or more repositories may then be identified. For example, if two repositories a and b contain files A, B and C, and repository c contains files D and E, then repositories a and b are selected. The contained files, for example A, B and C in the example above, are referred to as the contained files.

If multiple repositories have been selected since they contain the maximal group of files, a value may be determined for each repository, and the repository that has the highest value may be selected. The highest value can be determined upon the number of files in the repository, such that a smaller repository containing the same number of files from the original collection is preferred. Other criteria may relate to a popularity index of a repository, to the number of external links existing to a repository, or to their quality, for example links from well known or approved sites may contribute to the value more than other links. It will be appreciated that other criteria may also be applied. It will be appreciated that other selection criteria may be used for the selecting the repository. Once the best repository is selected in accordance with the value, the best tag associated with the repository, out of all tags in which the files are contained, may be selected. In some exemplary embodiments, a tag that contains most of the files, or a tag that is marked as release tag may be selected.

The process may then repeat for the collection of files excluding the files contained in the selected repository and tag. Thus, in each iteration repositories containing the maximal number of files from the original files excluding the contained files are indicated, the best repository is selected, and then the best tag is selected.

The resulting combinations of best repository and tag, and the files contained in each combination may then be output.

Another technical solution relates to a compact representation of the tags containing each file. Each tag is associated with a value, such as a hash value between 0 and the number of available tags. It will be appreciated that each file is comprised in a relatively small number of tags, for example up to a few hundreds out of hundreds of millions of existing tags. Thus, a vector indicating for each tag whether the file is contained therein, may be very long and very sparse. A compact representation is provided which is divided into a sequence of byte pairs, wherein each pair indicates a number of consecutive one or zeros. Within each pair, the first byte is a code indicating how the second byte is to be interpreted, i.e., what mathematical operator is to be applied to the binary number represented by the second byte and whether it relates to ones or zeros. Thus, the representation can provide “W zeros, X ones, Y ones, Z zeros”, etc. since most of the vector consists of zeros, this presentation is significantly more compact then allocating a bit for each tag.

One technical effect of utilizing the disclosed subject matter is the identification of the repositories and tags which contain files from an original collection. The provided repositories and tags combinations present higher value than other combinations, and are thus more likely to be the repositories and tags which the user of the original files indeed used.

Another technical effect of utilizing the disclosed subject matter is the provisioning of a compact representation of the file-tag containing relationship, which provides for space and time efficient determination of the repository and tags. The amount of repositories, tags and files is such that ordinary data structure cannot accommodate efficiently the required information and provide for performing operations thereon. The efficiency also provides for scalability of the apparatus and method, such that even significant increase in the number of existing repositories and tags does not cause significant increase in the time and space requirements of the apparatus and method.

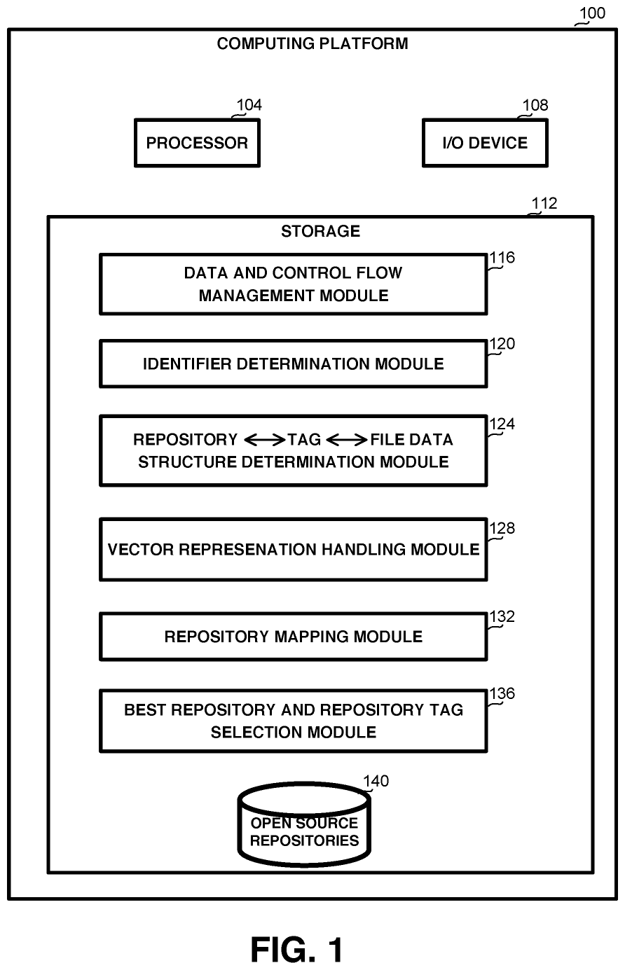

Referring now to FIG. 1 showing a block diagram of a system for determining open source usage in user source files, in accordance with some exemplary embodiments of the subject matter.

The system may comprise one or more computing platforms 100, which may be for example a server computing platform associated with an open source database.

In some exemplary embodiments of the disclosed subject matter, computing platform 100 can comprise processor 104. Processor 104 may be any processor such as a Central Processing Unit (CPU), a microprocessor, an electronic circuit, an Integrated Circuit (IC) or the like. Processor 104 may be utilized to perform computations required by the apparatus or any of it subcomponents.

In some exemplary embodiments of the disclosed subject matter, computing platform 100 can comprise an Input/Output (I/O) device 108 such as a display, a pointing device, a keyboard, a touch screen, or the like. I/O device 108 can be utilized to provide output to and receive input from a user.

Computing platform 100 may comprise a storage device 112. Storage device 112 may be a hard disk drive, a Flash disk, a Random Access Memory (RAM), a memory chip, or the like. In some exemplary embodiments, storage device 112 can retain program code operative to cause processor 104 to perform acts associated with any of the subcomponents of computing platform 100.

Storage device 112 can store, or be operatively connected to user code storage 132, storing a multiplicity of files associated with the user, wherein it may be required to check whether one or more of the source files comprise open source snippets. The files may comprise source code, binary, or the like.

Storage device 112 can store the modules detailed below. The modules may be arranged as one or more executable files, dynamic libraries, static libraries, methods, functions, services, or the like, programmed in any programming language and under any computing environment.

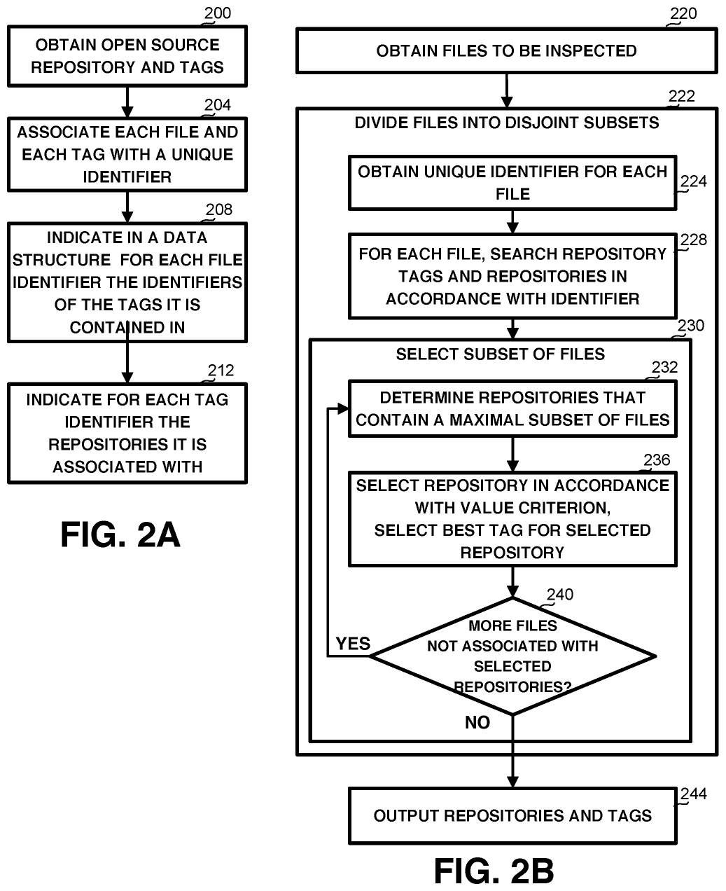

Storage device 112 can store data and control flow management module 116, for managing the control and data flow of the apparatus, such that modules are invoked at the correct order and with the required information, as detailed below in association with the modules description and with the flow charts of FIGS. 2A and 2B. For example, data and control flow management module 116 can be configured to execute the method of FIG. 2A periodically, such as every week or every month,

Storage device 112 can store identifier determination module 120, for determining a unique identifier for each file and each tag, and optionally each repository. The identifier may be determined as a hash value, such that each file is assigned a number between 0 and the number of files minus one (or in accordance with a different enumeration), and similarly for the repository tags and the repositories.

Storage device 112 can store file to tag and repository tag to repository data structure determination module 124. Module 124 is configured to associate a data structure with each file. The data structure indicates for each repository tag whether the file is contained in the repository tag. Each such data structure may be associated with an identifier indicating the file to which the data structure relates.

A similar data structure can be associated with each tag indicating which repositories it is included it. Reverse data structures, i.e., a data structure indicating for each repository tag the files associated with it may be attached to each repository tag, and a data structure indicating for each repository the repository tags associated with it may be attached to each repository.

Storage device 112 can store auxiliary data structure representation handling module 128 configured to provide compact representations of the as detailed below.

Storage device 112 can store repository mapping module 132 for receiving a file and determining its identifier. Once the identifier is known, the repository tags in which the file is contained can be retrieved from the data structure associated with the file. The repositories with which the repository tags are associated can then be retrieved as well, such that the collection of all repositories with which one or more files are associated is obtained. Since this may amount to a large volume, similar optimization can be used, for example describing the containment in a sparse vector in which each entry is 0 if there is mapping and 1 otherwise, and representing the vector as grouping of the 0s and 1s.

Storage device 112 can store best repository and repository tag selection module, configured to apply the value criterion in order to select the best repository for a subset of the files.

It will be appreciated that the modules above can be divided between a multiplicity of computer platforms, each associated with one or more processors. For example, the functionality may be divided between a user computing platform which can compute the identifier for each file, and a server that determines the repositories and tags containing the files.

Referring now to FIGS. 2A and 2B showing a flowchart of steps in a preparatory method and in a runtime method, respectively, for determining whether and which open source repositories and tags are used in a given collection of files, in accordance with some exemplary embodiments of the subject matter.

FIG. 2A is a flowchart comprising preparatory steps in preparing a database of open source repositories for receiving files and determining whether and which repository the files belong to.

At step 200, an open source repository, and optionally one or more repository tags associated therewith may be received. Each repository and repository tags may comprise a multiplicity of files, in source code, in binary or in any other manner.

At step 204, each file is associated with a unique identifier, for example a unique name or hash value. The term unique may refer to uniqueness among the files, the repositories and the tags, such that a certain identifier may be associated with a certain file and with a certain tag, but not with two files, two tags or two repositories.

At step 208, a first data structure is created, such as an array which comprises an entry for each file indicated by its identifier. Each entry in the data structure is associated with a second data structure indicating which repository tags the file is contained in.

A typical database can comprise millions of repositories, hundreds of millions of tags, and billions of files. Thus, it is required to indicate for each file whether it is contained in each of hundreds of millions of tags. However, each file is typically associated with only hundreds or thousands of repository tags. Thus, representing the second data structure in an array, for example a bit array, will create a very large and very sparse array, i.e., an array that contains significantly more zeros than ones, which is therefore highly inefficient in space and computation time.

Thus, a compact data structure can be constructed, which can represent the same information. The data structure may be implemented as an ordered sequence of byte pairs, wherein each pair indicates a number of consecutive one or zeros. Within each pair, the first byte is a code indicating how the second byte is to be read, i.e., what mathematical operator is to be applied to the binary number represented by the second byte, and whether it relates to ones or zeros. Since most of the vector consists of zeros, this presentation is significantly more compact then allocating even a single bit for each tag.

For example, the code implemented by the first byte of each pair may be as follows:

00000001—the next byte is number of zeros

00000010—the next byte is number of ones

00000011—multiplication of the next number by two gives the number of zeros

00000100—multiplication of the next number by two gives the number of ones

00000101—multiplication of the next number by three gives the number of zeros

00000110—multiplication of the next number by three gives the number of ones

00100000—two to the power of the next number gives the number of zeros

00100001—two to the power of the next number gives the number of ones

In one example, let s be the sequence of tags, wherein the code that represents the 1000 first tags is: 00000110 11111111 00000010 11101011. The first byte is 00000110, which indicates that a multiplication of the number represented by the second byte by three gives a number of ones. The second byte is 11111111, which is 255, thus this byte represents 255*3=765 ones. The third byte is 00000010, which indicates that the number represented by the second byte is a number of ones. The fourth byte is 11101011 which is 235. Thus, this number represents 765+235=1000 consecutive ones. In another example, if the code that represents the following tags is: 00000101 11111111 00000001 11101010 00000110 11111111 00000010 11101011, then: the first byte is 00000101, which indicates that a multiplication of the number represented by the second byte by three gives a number of zeros. The second byte is 11111111, which is 255, thus this byte represents 255*3=765 zeros. The third byte is 00000001, which indicates that the number represented by the second byte gives a number of zeros. The fourth byte is 11101010, which is 234, thus this byte represents 234 zeros. The fifth byte is 00000110, which indicates that a multiplication of the number represented by the second byte by three gives a number of ones. The sixth byte is 11111111, which is 255, thus this byte represents 255*3=765 ones. The seventh byte is 0000010, which indicates that the number represented by the eighth byte gives a number of ones. The eighth byte is 11101011, which is 235, thus this byte represents 235 ones. The vector is thus: 765+234=999 zeros followed by 765+235=1000 ones.

Additionally, information may be associated with one or more repositories or tags, including for example popularity index, a number of links existing to a repository or a tag, or the like.

On step 212, a similar data structure and compact representation can be associated with each repository tag, indicating which repositories the repository tag is associated with.

In some embodiments, the reverse data structures can also be created, indicating for each repository which repository tags relate to it, and for each repository tag which files are contained therein.

Referring now to FIG. 2B, showing a flowchart of steps in a method for determining whether a given collection of files comprises open source files, and from which repository.

On step 220, a given collection of files is provided, in source code, binary or any other manner(s) consistent with the manner(s) in which files were obtained and processed in the method of FIG. 2A.

On step 222, the given collection of files is divided into disjoint subsets, wherein at least one subset comprises given files that are contained in one repository and one repository tag. The repository and repository tag may be selected as better than other repository and repository tag combinations, in accordance with a criterion.

On step 224, a unique identifier is obtained for each given file. If the unique identifier is different from the unique identifiers obtained on step 204 for the files of all available repositories and repository tags, the given file is not contained in any repository. In alternative embodiments, if the identifier is equal to an identifier associated with an existing file, the existing file and the given file may be compared, and if they are different, then the given file is not an open source file.

Otherwise, i.e., the given file exists in the database, then on step 228 the data structure associated with each database file corresponding to the given file is examined. The repository tags and then the repositories associated with the given file are determined from the data structure. This examination is fast and efficient due to the usage of a compact representation, such as the compact representation disclosed above.

On step 230, a subset of the given files is selected.

On step 232, repositories that contain a maximal subset of given files are determined. The repositories may be termed as repositories having a positive evidence. As detailed above, on step 228, the repositories associated with each given file are determined. The files can then be divided into groups, such that files associated with the same repositories are assigned to the same group. The largest group, i.e. the group having the largest number of files, may be selected. If multiple groups having the same maximal number of files exist, one of them can be selected arbitrarily to be processed first, following processing of the other groups. For example, if the given files are f₁ . . . f₇, and the repositories are Rₐ . . . R_{d}, such that f₁, f₂, and f₃ are present in Rₐ and R_{b}, f₄, f₅, and f₆ are present in Rₐ and R_{b}, and f₇ is present in R_{d}, then the group consisting of f₁, f₂, and f₃ or the group consisting of f₄, f₅, and f₆ can be processed first.

On step 236, one or more value criterion is applied towards all repositories associated the selected group, to obtain a value indication. In the example above, if the group consisting of f₁, f₂, and f₃ is selected, then the criterion may be assessed for repositories Rₐ and R_{b}.

The value indication may thus be based on a number of factors, for example one or more factors selected from, but not limited to, the following: usage popularity, number of external links to the repository, number of repository tags existing for the repository, or the like. The factors may also include factors associated with the given files. For example, if Rₐ comprises 50 files and R_{b} comprises 30 files, then Rb may be assigned a higher value, since Rₐ and R_{b} comprise the same number of given files (this is the subset that is currently being processed), thus a larger part thereof is being used in Rb than in Rₐ. In particular, if R_{b} is contained in Rₐ, then R_{b} may be assigned a higher value. Further, if one repository is identified as an “origin”, while other repositories are forked, mirrored or copied from the origin repository, the origin repository is assigned a higher value. In another example, a repository to which a link from a well-known source exists (or a repository to which more such links exist), may be assigned higher value.

Once the best repository is selected, the best repository tag associated with this repository may be selected. In some examples, the repository tag can be selected in accordance with dates, wherein newer tags may be preferred and selected, in accordance with a name for example a tag named “do not release” may not be selected, or the like.

On step 240, it may be determined whether more given files exist, which are note associated with the repositories that have been selected. In the example above, the files would be f₄ . . . f₇. Then, one or more repositories can be determined on step 232 for f₄ . . . f₆, and if multiple repositories are determined, the best can be selected on step 236.

The process can then repeat for f₇, after which on step 244 the selected repositories and tags may be output. Output may include, for example, displaying the triplets comprising <repository, repository tag, file name> to a user for each file associated with a repository and a repository tag. The file contents may also be displayed. Outputting may also include storing the triplets in a file, transmitting them to a user or application, or the like.

The system can be a standalone entity, or integrated, fully or partly, with other entities, which can be directly connected thereto or via a network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
obtaining a multiplicity of files;
dividing the multiplicity of files into disjoint file subsets, such that all files in each file subset from the disjoint file sets are contained in a different combination of repository and repository tag, comprising:
searching for repository tag and repository combinations in which each file is contained; and
selecting a subset of the repository tag and repository combinations which contain all files, such that at least one repository and repository tag combination containing a collection of files is selected over at least one other repository and repository tag combination containing the collection of files, in accordance with at least one value indication associated with each repository and repository tag combination; and
outputting the repository and repository tag combination for each of the file subsets.

2. The method of claim 1 wherein the at least one value indication relates to meta data associated with the repository or repository tag.

3. The method of claim 1 wherein the at least one value indication comprises a popularity index of the repository or repository tag.

4. The method of claim 1 wherein the at least one value indication comprises a number or quality of external links pointing at the repository.

5. The method of claim 1 wherein the at least one value indication comprises a number of files in the files subset contained in a repository.

6. The method of claim 1 wherein the at least one value indication comprises a ratio between a number of files in the files subset and a number of files in a repository that contains the files, such that a higher ratio indicates a higher value for the indication.

7. The method of claim 1, wherein the at least one repository and repository tag combination is selected over a second repository and second repository tag combination, wherein the second repository contains the repository.

8. The method of claim 1 wherein searching for the repository tag and repository combinations comprises using a vector representation of repository tags associated with each repository and files associated with each repository tags.

9. The method of claim 6 wherein the vector representation is a compact vector representation.

10. The method of claim 9 wherein the vector representation comprises a sequence of byte pairs, wherein a first byte in each byte pair comprises a code and wherein the second byte in each byte pair represents a number to be read in accordance with the code.

11. The method of claim 10 wherein the code is selected from the group consisting of:
a value of the second byte represents a number of consecutive zeros;
the value of the second byte represents a number of consecutive ones;
the value of the second byte multiplied by two represents a number of consecutive zeros;
the value of the second byte multiplied by two represents a number of consecutive ones;
the value of the second byte multiplied by three represents a number of consecutive zeros;
the value of the second byte multiplied by three represents a number of consecutive ones;
two in a power of the value of the second byte represents a number of consecutive zeros; and
two in the power of the value of the second byte represents a number of consecutive ones.

12. The method of claim 1 wherein selecting the subset of the repository tag and repository combinations comprises:
determining at least two repositories containing a first set of files; and
selecting from the at least two repositories, a repository whose value is higher than a value of another of the at least two repositories.

13. The method of claim 12 further comprising repeating said determining and said selecting from the at least two repositories, for the files excluding the first set of files.

14. A computerized apparatus having a processor, the processor being configured to perform the steps of:
obtaining a multiplicity of files;
dividing the multiplicity of files into disjoint file subsets, such that all files in each file subset from the disjoint file sets are contained in a different combination of repository and repository tag, comprising:
searching for repository tag and repository combinations in which each file is contained; and
selecting a subset of the repository tag and repository combinations which contain all files, such that at least one repository and repository tag combination containing a collection of files is selected over at least one other repository and repository tag combination containing the collection of files, in accordance with at least one value indication associated with each repository and repository tag combination; and
outputting the repository and repository tag combination for each of the file subsets.

15. A computer program product comprising a computer readable storage medium retaining program instructions, which program instructions when read by a processor, cause the processor to perform a method comprising:
obtaining a multiplicity of files;
dividing the multiplicity of files into disjoint file subsets, such that all files in each file subset from the disjoint file sets are contained in a different combination of repository and repository tag, comprising:
searching for repository tag and repository combinations in which each file is contained; and
selecting a subset of the repository tag and repository combinations which contain all files, such that at least one repository and repository tag combination containing a collection of files is selected over at least one other repository and repository tag combination containing the collection of files, in accordance with at least one value indication associated with each repository and repository tag combination; and
outputting the repository and repository tag combination for each of the file subsets.
